(19) United States
(12) Patent Application Publication
(10) Pub. No.: US 2008/0141285 A1
(43) Pub. Date: Jun. 12, 2008

(54) OPEN HOME NETWORK FRAMEWORK AND METHOD FOR OPERATING THE SAME

(76) Inventors: Hoon-Ki LEE, Daejon (KR); Jong-Hoon LEE, Daejon (KR); Jung-Tae KIM, Daejon (KR); Eui-Hyun PAIK, Daejon (KR); Kwang-Roh PARK, Daejon (KR)

Correspondence Address: LADAS & PARRY LLP, 224 SOUTH MICHIGAN AVENUE, SUITE 1600, CHICAGO, IL, 60604, US

(21) Appl. No.: 11/951,628

(22) Filed: Dec. 6, 2007

(30) Foreign Application Priority Data
Dec. 8, 2006 (KR) 10-2006-0125145

(51) Int. Cl. G06F 9/44

(52) U.S. Cl. 719/328

(57) ABSTRACT

Provided are an open home network framework and a method for operating the same. The method includes: forming an user application layer having interfaces to manage an individual service application software and a platform; forming a core framework layer having a framework management function based on an individual service control logic and service control logic for hardware-dependent control; forming a communication layer to process hardware interworking services; forming a service application programming interface (API) for providing interworking interfaces between the user application layer and the core framework layer; forming an adaptor for providing interworking interfaces between service components and legacy components; and forming a communication API for providing hardware-independence between the core framework layer and the communication layer to control a hardware and a device.

### CROSS-REFERENCE TO RELATED APPLICATIONS

The present invention claims priority of Korean Patent Application No. 10-2006-0125145, filed on Dec. 8, 2006 which is incorporated herein by reference.

### BACKGROUND OF THE INVENTION

1. Field of the Invention

The present invention relates to an open home network framework and a method for operating the same; and, more particularly, to an open home network framework which can provide a user-customized service and independent application software from a hardware provider or a middleware provider by providing an independent service operating environment from hardware-dependent characteristics based on a common framework and a method for operating the same.

This work was supported by the Information Technology (IT) research and development program of the Korean Ministry of Information and Communication (MIC) and the Korean Institute for Information Technology Advancement (IITA) [2005-S-112-2, “A Development of Open Home Network Framework Technologies”].

2. Description of Related Art

In a conventional home network environment, hardware, driver, middleware and user application layer service are provided by one hardware platform for a new service.

Therefore, a provider of the hardware has to develop the middleware and the user application layer service as well as the hardware, and a provider of the user application layer service has to develop hardware platform for providing the new service. When the service or the hardware is changed, not only software but the hardware have to be changed, and thus resources are wasteful. In addition, when the new service is provided through a platform in the home network environment, interface information is needed to interwork services of a specific platform. Therefore, maintenance and repair occur according to hardware analysis nothing to do with an application service.

In various application services provided in the home network environment, there are a broadcasting service, a home care service, an appliance control service and a home entertainment service.

Each of the above services is provided independently by the specific platform. When a user wants a new service, another hardware platform for providing the new service is required. Whenever the new service is added, the hardware platform for the new service is added, and thus, additional cost may occur to provide the new service. Also, recent application services include user customized service such as TV portal and independent single services. Therefore, an environment for providing multiple and complex services is required. Since conventional platforms do not provide a common framework for supporting the multiple and complex service, there is a waste of resources such as duplication investment in position of the user.

### SUMMARY OF THE INVENTION

An embodiment of the present invention is directed to providing an open home network framework which can provide a user-customized service and independent application software from a hardware provider or a middleware provider by providing an independent service operating environment from hardware-dependent characteristics based on a common framework and a method for operating the same.

Other objects and advantages of the present invention can be understood by the following description, and become apparent with reference to the embodiments of the present invention. Also, it is obvious to those skilled in the art to which the present invention pertains that the objects and advantages of the present invention can be realized by the means as claimed and combinations thereof.

In accordance with an aspect of the present invention, there is provided a method for operating an open home network framework, including: forming an user application layer having interfaces to manage an individual service application software and a platform; forming a core framework layer having a framework management function based on an individual service control logic and service control logic for hardware-dependent control; forming a communication layer to process hardware interworking services; forming a service application programming interface (API) for providing interworking interfaces between the user application layer and the core framework layer; forming an adaptor for providing interworking interfaces between service components and legacy components; and forming a communication API for providing hardware-independence between the core framework layer and the communication layer to control a hardware and a device.

In accordance with another aspect of the present invention, there is provided an open home network framework, including: a user application layer for providing a user-oriented user interface (UI) and a service offered by an actual service control modules through interworking interfaces; a core framework layer for managing service control logic and performing operations related to service control according to a specific service selection from the user application layer or a request of service from other devices or platforms in a home network environment; a communication layer for controlling a predetermined platform-based service; a service application programming interface (API) including a plurality of service groups to interwork between the user application layer and the core framework layer and defining service control based on service characteristics and interface related to information transmission/reception; and a communication API for providing independent service even though a hardware of hardware-dependent service is changed.

### BRIEF DESCRIPTION OF THE DRAWINGS

FIG. 1 is a diagram illustrating various home network devices in a conventional home network environment.

FIG. 2 is a diagram illustrating an open home network framework in accordance with an embodiment of the present invention.

FIG. 3 is a detailed diagram illustrating the open home network framework in accordance with an embodiment of the present invention.

FIG. 4 is a diagram illustrating interworking between devices or platform in a home network environment using the open home network framework in accordance with an embodiment of the present invention.

FIGS. 5A and 5B are detailed diagrams illustrating a core framework layer of the open home network framework in accordance with an embodiment of the present invention.

FIG. 6 is a diagram illustrating a method for operating the open home network framework in accordance with an embodiment of the present invention.

### DESCRIPTION OF SPECIFIC EMBODIMENTS

The advantages, features and aspects of the invention will become apparent from the following description of the embodiments with reference to the accompanying drawings, which is set forth hereinafter.

FIG. 1 is a diagram illustrating various home network devices in a conventional home network environment.

In the conventional home network environment, there are various formats of platforms. Services or resources cannot be shared between the platforms. Different format of the platform is needed in order to provide another service.

Generally, 4 types of platforms are provided in the home network environment.

A ‘device A’ 101 is a platform of a unified environment and provides a structure including a hardware in a communication layer, a service control logic in a core framework layer and an application service in a user application layer. Mainly a settop box like a home server provides the same platform format of the device A.

A ‘device B’ 102 is a platform and provides a structure including a control logic in the core framework layer for providing application services and a user application for providing the application through an user interface (UI) in the user application layer. For example, the platform includes a hardware-independent application service and an upper application based on the hardware-independent application service such as a media server.

A ‘device C’ 103 is a simple platform using the application service provided by the other devices in the home network environment. In the ‘device C’, e.g., personal digital assistants (PDA), there are applications for providing services to a user in the home network environment, and the logic for controlling the applications and providing service exists in other devices.

A ‘device D’ 104 is a hardware-dependent device such as a home gateway. It provides a remote control server in the home network environment. That is, it provides a hardware-dependent service controlling and transmitting services by collecting control information from the other platform, which is controlled by the user.

As described above, the conventional home network environment provides a different device type providing dependent services based on independent platforms of each device.

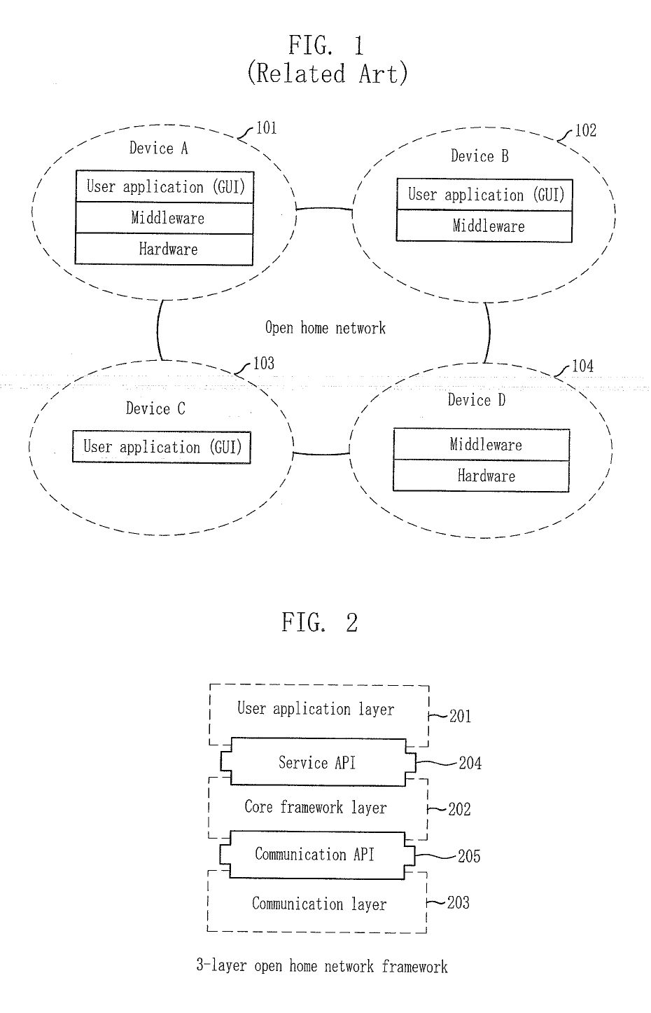

FIG. 2 is a diagram illustrating an open home network framework in accordance with an embodiment of the present invention.

In the home network environment, there are various formats of home devices or platforms. The home devices include the hardware, the middleware and the application service. Therefore, if services and devices based on new home network are changed, environments should be constructed for providing additional services.

The present invention suggests a method for providing the services without changing the application service and related service control modules although the service or the hardware such as the device are changed based on an open home network framework (OHF). Service provision and interact operation can be secured by standardizing an interworking interface between the application service in the user application layer and the service control logic in the communication layer and framework management function for the service control logic. The open home network framework may provide downloadable service through Internet or interworking of the application service in the home network environment.

As shown in FIG. 2, the open home network framework (OHF) provides a service or hardware resource sharing to the various formats of devices or platforms in the home network environment. The OHF composed of 3 layers.

That is, the OHF includes a user application layer 201 for providing interface to the user based on service profile information, a core framework layer 202 for controlling and managing the service, and a communication layer 203 for processing hardware interworking service. In the OHF, various application services can be independently provided through the specific hardware platform based on the 3 layers.

The user application layer 201 provides a user-oriented user interface (UI), and provides a service through interworking interface with actual service control modules. Also, the user application layer manages and controls a user interface package or an application layer package for providing a general static service and a customized service such as dynamic service downloaded through Internet.

The core framework layer 202 manages service control logic. When the specific service is selected in the user application layer 201, or other devices or platforms request for proving service in the home network environment, the core framework layer 202 performs successive operations related to the service control.

The communication layer 203 is related to the hardware-based service control and controls platform-based services.

In order to maintain independence between the layers in the OHF, an independent interface, i.e., service API, may be used to provide control and data transmission/reception between the user application layer 201 and the core framework layer 202.

The service API is formed by each service group, and each service group defines the service control and interface related to information transmission/reception corresponding to service characteristics.

Also, the 3-layer OHF defines a communication API 205 for providing service independently, although the hardware is changed. That is, service can be provided to the user by an interworking structure based on a common interface, even though the hardware platform is changed.

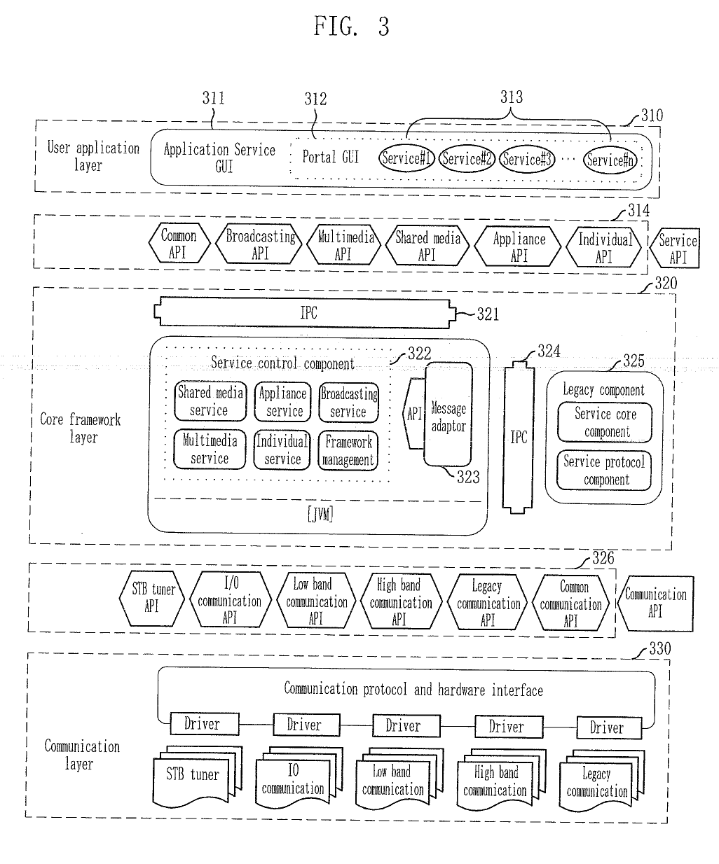

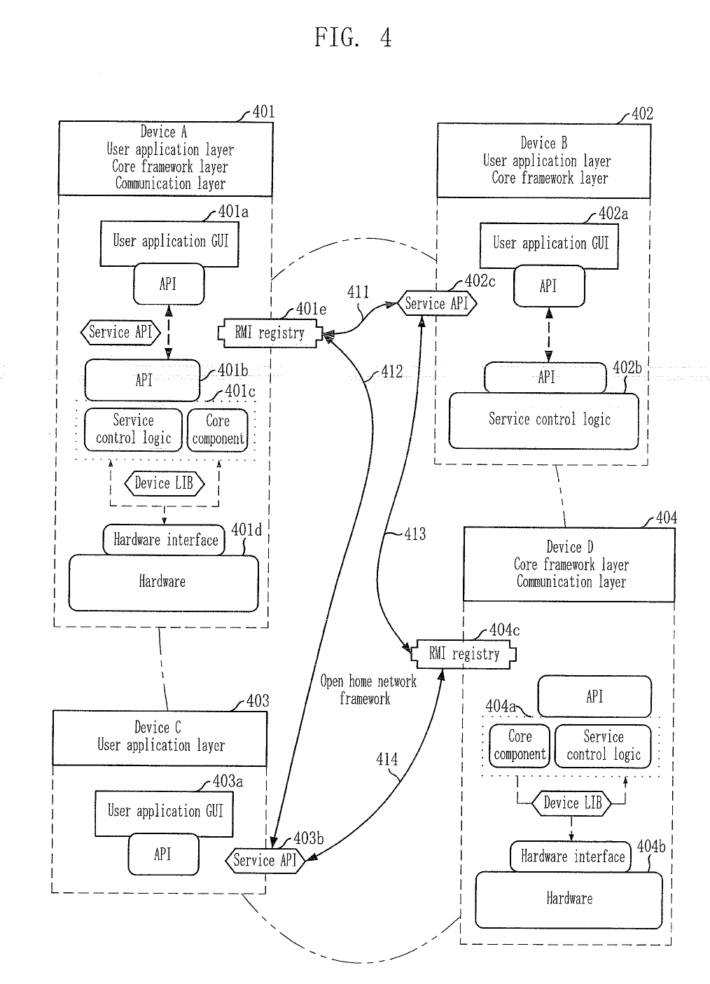

FIG. 3 is a detailed diagram illustrating the open home network framework in accordance with an embodiment of the present invention.

As described above, the OHF includes 3 layers, and each layer has internal structures as shown in FIG. 3.

The user application layer 310 provides a direct F interface with the user. It controls the user-oriented user interface (UI) based on information inputted through a mouse and a keyboard or a wireless remote controller from the user.

The user application layer 310 includes an application service graphic user interface (GUI) 311 for providing application services. The application service GUI 311 can exist as separate application services for each individual service and can be managed by a portal GUI 312 which manages the user application layer 310. Downloaded service GUI package through Internet is managed by the portal GUI 312 of user application layer.

The portal GUI 312 has control logics of individual services 313, and assigns and manages a service menu customized to a platform user.

As described above, the user application layer 310 is implemented as a separate application service GUI related to service control by managing a final displaying screen of service in user's position.

Specified service API 314 is determined for providing interworking between the user application layer 310 and the core framework layer 320.

The service API 314 includes a plurality of detailed interfaces for classifying and controlling various application services in the home network environment. The service API 314 includes a common API, a broadcasting API, a shared media API, a multimedia API, an appliance API and an individual API. The common API manages service control information. The broadcasting API provides broadcasting service. The shared media API provides sharing of home media and outside home media. The multimedia API controls and manages multimedia services such as image or voice service. The appliance API controls various appliances in home network environment. The individual API registers new API of download service through Internet and provides service interworking.

The core framework layer 320 includes control logic of the services and devices supporting the open home network framework (OHF). The core framework layer 320 includes an inter-process communication (IPC) part 321, a service control component 322 for controlling each service group, interface parts 323 and 324 for interworking with hardware-dependent service, and a legacy component 325 which is control logic of the hardware-dependent service.

The inter-process communication (IPC) part 321 processes messages for transmitting/receiving message to provide service interworking with the user application layer 310.

The service control component 322, the actual control logic of the service, manages services for each detailed service item group. When a dynamic service is added, the service control component 322 determines a service group of the dynamic service based on the service profile information and updates interworking interface.

Most of hardware-dependent service control logics operate in the service control component 322, service control section directly operating at a platform such as a hardware control operates in the legacy component 325.

The legacy component 325 includes parts operating as a daemon and library type. Control information is transmitted and received through a message adaptor 323 for supporting heterogeneous of program languages between the service control component 322 implemented by Java language and the legacy component 325 implemented by C language to control hardware.

The message adaptor 323 processes service information presented by the two program languages through an inter-process communication (IPC) part 324, and thus the conventional service control logic can be recycled.

A communication layer 330, which is a lower layer of the open home network framework (OHF), provides services based on a specific hardware platform, and the communication layer 330 cannot exist independently to provide service. The platform-dependent elements can be separated by the interworking structure through a communication API 326.

The communication API 326 defines interworking interfaces to control each hardware device, and provides a structure for controlling and managing hardware resources used in the core framework layer 320. That is, the communication API 326 includes a STB tuner API, an input/output (I/O) communication API, a low band communication API, a high band communication API, a legacy communication API and a common communication API to control various hardware devices in the home network environment. The STB tuner API controls a broadcasting tuner related to the broadcasting service. The I/O communication API controls I/O driver provided in the platform. The low band communication API controls hardware providing data with low a transmission rate. The high band communication API controls hardware providing data with a high transmission rate. The common communication API recognizes newly added hardware drivers or devices and transmits information on the added hardware drivers or devices to a framework management function through the common interface.

FIG. 4 is a diagram illustrating interworking between devices or platform in a home network environment using the open home network framework in accordance with an embodiment of the present invention.

As described in FIG. 1, there are various formats of devices in the home network environment, and service interworking between the devices is impossible. However, in case of a platform supporting the open home network framework in accordance with the present invention, the interworking structure and a structure sharing services can be provided as shown in FIG. 4.

A ‘device A’ 401 is a platform including 3 layers of the open home network framework. The platform has a structure for providing home application service such as a home server, the service control logic and the hardware.

A user application graphic user interface (GUI) 401a and a service control logic 401c are interworked through an application programming interface (API) 401b for transmitting and receiving control messages and service data. The ‘device A’ having 3 layers includes the hardware and hardware interface 401d in the communication layer and the control logic for interworking with the service control logic 401c. Also, other devices or platforms 402 and 403 of the home network can use the service API through interworking with a remote method invocation (RMI) 401e for service control logic 401c provided by the core framework layer.

The RMI registry 401e is serviced by service APIs 402c and 403c of other devices 402 and 403 through the RMI interworking 411 and 412.

A ‘device B’ 402 is a platform including upper 2 layers of the open home network framework. The platform provides a media server or customized web services, includes a user application GUI 402a and interworks with the service control logic 402b. Also, in order to be provided services from other platforms 401 and 404 of the home network environment, the device B can be interworked based on API 411 and 413 registered in the RMI registry 401e and 404c.

A ‘device C’ 403 is a device for displaying information, i.e., final result of the service or inquiry, such as personal digital assistant (PDA). In the device C, most of service control logic is provided by other platforms 401 and 404 in the home network environment, only an application GUI 403a for processing and outputting information is provided. That is, actual control logic is provided by other devices 401 and 404 through the service APIs 402c and 403b interworking 412 and 414 with the RMI registry 401e and 404c.

A ‘device D’ 404 is a platform providing service related to hardware interworking. There is no direct interface with the user such as a home gateway, information related to the service is provided to other devices or terminals 402 and 403 in the home network environment.

The device D 404 includes a interworking structure related to the hardware 404b, a service control logic 404a, and a RMI registry 404c for providing service to other platforms or devices 402 and 403.

As described above, in order for the service interworking between the platforms and devices supporting the open home network framework, services are provided by RMI interworking 413 and 414 between devices 401 and 404 with service control logic and devices 402 and 403 with service APIs 402c and 403b.

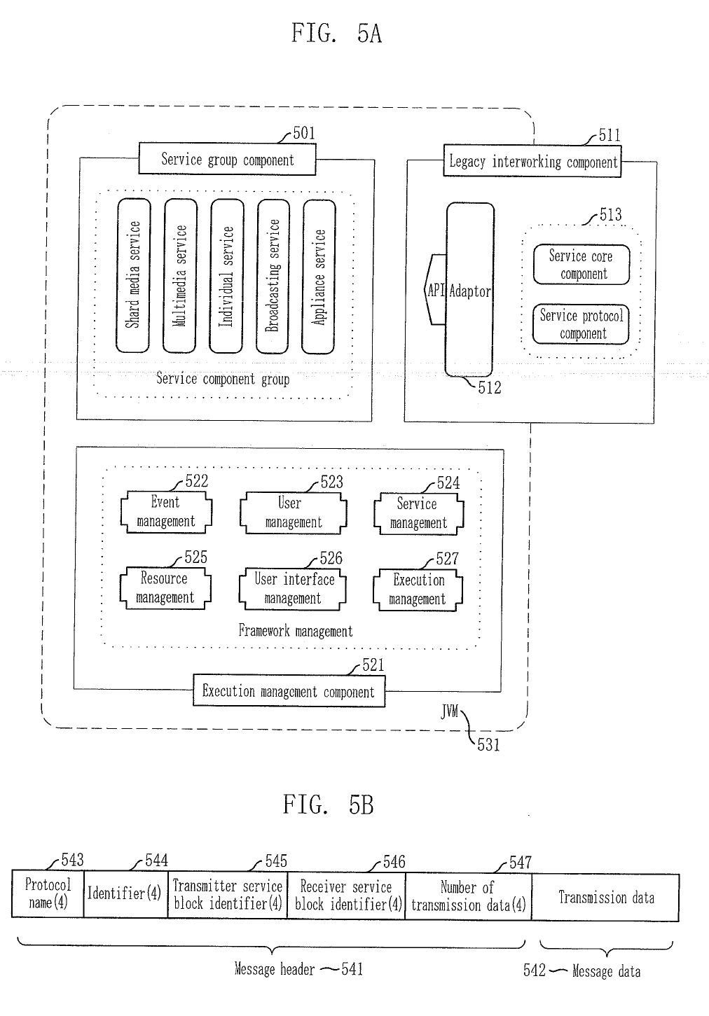

FIGS. 5A and 5B are detailed diagrams illustrating a core framework layer of the open home network framework in accordance with an embodiment of the present invention.

As shown in FIG. 5A, the core framework layer includes a plurality of components.

A service group component 501 is a group of service components, and includes control logic, execution logic and processing logic of service for each service group.

The service group component 501 classifies five service items for service groups, and the service interworking between the five service items is possible.

The service API 314 described in FIG. 3 is interworked with each service group component, and provides the interworking structure for providing service to other devices or platforms in the home network.

A legacy interworking component 511 includes a legacy component 513 and an adaptor 512. When the service is provided by interlocking with an operating system (OS) such as a hardware driver, hardware-dependent characteristics are included. The legacy component provides a hardware-dependent service.

Generally, the open home network framework uses JAVA language to operate hardware-independently, and thus JAVA virtual machine 531 is used. Using the JAVA language increases system independence and implantation. However, in case of a system-dependent service, when C language is used for the control logic, transmitting/receiving of control information and processing data cannot be normally performed due to heterogeneity of the language. Therefore, the adaptor 512 is used to solve the heterogeneity of the language. The adaptor 512 defines a standard format based on an interworking protocol, analyzes and process messages.

FIG. 5B is a diagram illustrating a structure of an interworking message.

As shown in FIG. 5B, the interworking message includes a message header 541 for processing message and message data 542 having transmission data. The message header 541 is divided into 5 detailed fields 543 to 547.

The message header 541 includes a protocol name 543 for defining a transmission protocol, an identifier 544 for defining transmitting and receiving message, a transmitter service block identifier 545, a receiver service block identifier 546, and the number of transmission data 547.

The adaptor 512 analyses the message header 541 and transmits the message to a corresponding block.

In detail components of the core framework layer, there is an execution management component 521 for total framework operation and management. The execution management component 521 manages processing and control required information related to all services, users, resources to provide service. The execution management component 521 includes 6 management functions, i.e., an event management 522, a user management 523, a service management 524, a resource management 525, a user interface management 526 and an execution management 527.

The event management 522 processes various system events, alarm information and information related to service history occurring the platform of the open home network framework. The user management 523 controls authority of platform and service authority of the user. The service management 524 controls a service to be provided to the user and determines and controls service policy related to a dynamic service and a multiple-service. The resource management 525 determines usage of services for each user through hardware resource provided by a specific hardware platform. The user interface management 526 manages control information of the user graphic interface in accordance with service access authority of the user. The execution management 527 performs functions related to the entire service execution and processes final service execution.

The above structure makes the execution management component 521 to provide stable and user-oriented dynamic/multiple services in the open home network framework.

Each function provided by the execution management component 521 can be limited according to specification of the platform of the open home network framework. The above limitation can be provided as an option of service management function, and thus stable service can be provided to the platform.

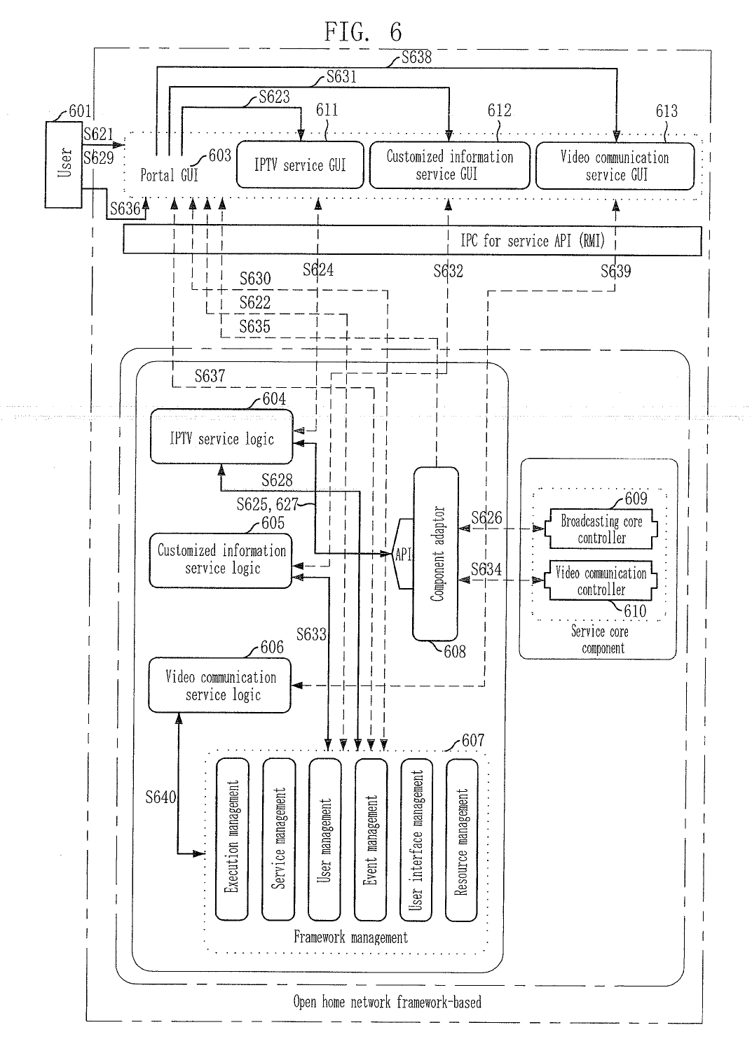

FIG. 6 is a diagram illustrating a method for operating the open home network framework in accordance with an embodiment of the present invention. Particularly, FIG. 6 shows control flows of three multiple services provided in a home server 602 referring the open home network framework.

That is, FIG. 6 is a diagram illustrating various services of the home network environment to provide user-oriented multiple services.

A user 601 can control all services provided by the home server 602 through a portal GUI 603 of the home server 602.

The user 601 selects an Internet protocol television (IPTV) menu of the portal GUI 603 through a remote controller in order to request an IPTV broadcasting service at step S621.

The portal GUI 603 receives an IPTV service request of the user, transmits a service admission request message to the framework management function 607 of the open home network framework at step S622.

When a service admission result is returned based on 6 functions of the framework management function 607 at step S622, the portal GUI 603 receives the service admission result and activates an IPTV service GUI 611 at step S623.

The IPTV service GUI 611 transmits a service start request message to an IPTV service logic 604 in order to start the IPTV broadcasting service at step S624.

The IPTV service logic 604 performs an initialization for service start, and transmits an IPTV displaying request message to a broadcasting core controller 609 at step S625.

Since the IPTV displaying request message transmitted to the broadcasting core controller 609 is made by JAVA language, a component adaptor 608 transforms the request message to a message having the standard format which can be recognized in the broadcasting core controller 609 and transmits the message to the broadcasting core controller 609 at step S626.

The broadcasting core controller 609 returns a processing result of the broadcasting output to the IPTV service logic 604 at step S604 and S627.

The IPTV service logic 604 informs that the IPTV broadcasting is provided normally to the framework management function 607 at step S628.

While the IPTV broadcasting is provided, the user 601 requests multiple services in order to receive a customized web service at step S629.

The portal GUI 603 transmits a multiple-service request message whether or not the IPTV broadcasting service and the customized web service can be provided simultaneously to the framework management function 607 at step S630.

The framework management function 607 returns a admission message of the multiple-service to the portal GUI 603 based on verification of resource information of the multiple-service and the user authority at step S630.

The portal GUI 603 receives the admission message of the multiple-service, and activates a customized information service GUI 612, e.g., a customized web service GUI for the multiple-service, at step S631.

The customized information service GUI 612 transmits a request to a customized information service logic 605 for outputting information of the multiple-service and starts the multiple-service at step S632.

The customized information service logic 605 informs that the information output is provided normally to the framework management function 607 at step S633.

While the above two services are provided, if a video communication is requested from an outside, a video communication controller 610, which first receives a video communication request message, transmits an alarm message to the user in order to notify reception of the video communication request message through the portal GUI 603 at step S634 and S635.

When the portal GUI 603 transmits the alarm message of the video communication request to the user 601, the user 601 responds connection or rejection of the video communication to the portal GUI 603 at step S636.

When the user requests the connection of the video communication, the portal GUI 603 transmits a triple-service admission request message to the framework management function 607 in order to execute triple-service at step S637.

The portal GUI 603 receives a triple-service admission result at step S637 and activates a video communication service GUI 613 at step S638.

The video communication service GUI 613 requests a connection of the video communication service to a video communication service logic 606 at step S639.

The video communication service logic 606 connects the video communication service, and transmits a service result to the framework management function 607 at step S640.

As above description, the structure suggested in the present invention includes service applications 603, 611, 612 and 613 in the user application layer, service control logics 604, 605 and 606 for controlling the service application and service APIs S622, S624, S630, S632, S635, S637, S639 performing interworking between the service application and the control logic.

In the framework in accordance with the present invention, the service interworking and the control logic accessing with other platform in the home network environment can be easily performed by providing independence for each layer. The final service providing platform and the service requesting platform may have different structures.

The present invention can provide a framework for operating various services provided in the home network environment. The framework can provide the secure service for multiple and downloaded services by managing users and services based on resource of the platform.

Also, in the present invention, the services, which is provided in the home network environment, can be received or provided to or from a local or remote location based on user application, service control logic, service API for interworking the user application and the service control logic and frame management function for managing the users, the services and the resources.

In addition, the open home network framework of the present invention can reduce an additional cost for buying new platform, efficiently manage the service redundancy in the home network environment, and provide the download service through Internet in real-time by separating a service accommodation and a service provision.

A structure making service interworking impossible and a hardware-dependency provided in the recent home network devices or platforms cannot be satisfied with user's demands. However, the user wants to be provided with various services anytime and anywhere. Moreover, fixed platforms or devices cannot support the users' demands and require high additional cost. Therefore, efficiency of the resources can be maximized by the open home network framework providing the dynamic service.

In the present invention, the home network devices provide the independent hardware, the independent application service and interworking through a common interface. Therefore, the present invention can provide interworking interface in order to ensure compatibility between an application software provider and a hardware platform provider.

The above described method according to the present invention can be embodied as a program and be stored on a computer readable recording medium. The computer readable recording medium is any data storage device that can store data which can be read by the computer system. The computer readable recording medium includes a read-only memory (ROM), a random-access memory (RAM), a CD-ROM, a floppy disk, a hard disk and an optical magnetic disk.

While the present invention has been described with respect to the specific embodiments, it will be apparent to those skilled in the art that various changes and modifications may be made without departing from the spirit and scope of the invention as defined in the following claims.

What is claimed is:

1. A method for operating an open home network framework, comprising:
forming an user application layer having interfaces to manage an individual service application software and a platform;
forming a core framework layer having a framework management function based on an individual service control logic and service control logic for hardware-dependent control;
forming a communication layer to process hardware interworking services;
forming a service application programming interface (API) for providing interworking interfaces between the user application layer and the core framework layer;
forming an adaptor for providing interworking interfaces between service components and legacy components; and
forming a communication API for providing hardware-independence between the core framework layer and the communication layer to control a hardware and a device.

2. The method of claim 1, wherein the forming the user application layer includes:
performing management of user application software, verification of service authority, application service switching control, service control based on interworking with the communication API through a portal graphic user interface (GUI);
receiving service control information from the framework management function of the core framework layer and activating individual application service GUI; and
at the portal GUI, receiving error message from the individual application service GUI and transmitting the error to the framework management function.

3. The method of claim 1, wherein the forming the core framework layer includes:
forming a service group component in accordance with individual service characteristics;
forming a legacy interworking component to accept and manage the service control logic;
forming an execution management component to manage the open home network framework; and
allowing the adaptor to interwork control message between the service group component and the legacy interworking component.

4. The method of claim 3, wherein the forming the service API includes:
forming a common API for managing service control information;
forming a broadcasting API for providing a broadcasting service;
forming a shared media API for sharing home media and outside home media;
forming a multimedia API for controlling and managing multimedia services;
forming an appliance API for controlling various appliances in home network environment; and
forming an individual API for registering a new API of download service through Internet and providing service interworking,
wherein the service API includes a plurality of detailed interfaces for classifying and controlling various application services in the home network environment.

5. The method of claim 3, wherein the forming the adaptor includes:
defining a standard format based on an interworking protocol; and
analyzing and processing a message,
wherein the message includes a protocol name for defining a transmission protocol, an identifier for defining transmitting and receiving the message, a transmitter service block identifier, a receiver service block identifier, the number of transmission data and transmission data.

6. The method of claim 3, wherein the forming the communication API includes:
forming a STB tuner API for controlling a broadcasting tuner related to a broadcasting service;
forming an I/O communication API for controlling I/O driver provided in the platform;
forming a low band communication API for controlling hardware which provides data with a low transmission rate;
forming a high band communication API for controlling hardware which provides data with a high transmission rate; and
forming a common communication API for recognizing newly added hardware drivers or devices and transmitting the newly added hardware drivers or devices to the framework management function through a common interface.

7. The method of claim 3, wherein the execution management component includes an event management, a user management, a service management, a resource management, a user interface management and an execution management.

8. An open home network framework, comprising:
a user application layer for providing a user-oriented user interface (UI) and a service offered by an actual service control modules through interworking interfaces;
a core framework layer for managing service control logic and performing operations related to service control according to a specific service selection from the user application layer or a request of service from other devices or platforms in a home network environment;
a communication layer for controlling a predetermined platform-based service;
a service application programming interface (API) including a plurality of service groups to interwork between the user application layer and the core framework layer and defining service control based on service characteristics and interface related to information transmission/reception; and
a communication API for providing independent service even though a hardware of hardware-dependent service is changed.

9. The open home network framework of claim 8, wherein the user application layer includes:
a portal graphic user interface (GUI) for performing management of user application software, verification of service authority, application service switching control, service control based on interworking with the communication API.

10. The open home network framework of claim 9, wherein the portal GUI receives service control information from a framework management function of the core framework layer and activates individual application service GUI.

11. The open home network framework of claim 10, wherein the portal GUI receives error message from the individual application service GUI and transmits the error to the framework management function.

12. The open home network framework of claim 8, wherein the core framework layer includes:
a service group component having components for providing individual service;
a legacy interworking component for accepting and managing the service control logic; and
an execution management component for managing the open home network framework,
wherein the core framework layer allows the adaptor to interwork control message between the service group component and the legacy interworking component.

13. The open home network framework of claim 8, wherein the service API includes:
a common API for managing service control information;
a broadcasting API for providing a broadcasting service;
a shared media API for sharing home media and outside home media;
a multimedia API for controlling and managing multimedia services;
an appliance API for controlling various appliances in home network environment; and
an individual API for registering a new API of download service through Internet and providing service interworking,
wherein the service API includes a plurality of detailed interfaces for classifying and controlling various application services in the home network environment.

14. The open home network framework of claim 8, wherein the adaptor defines a standard format based on an interworking protocol, analyzes and processes a message.

15. The open home network framework of claim 14, wherein the message includes a protocol name for defining a transmission protocol, an identifier for defining transmitting and receiving the message, a transmitter service block identifier, a receiver service block identifier, the number of transmission data and transmission data.

16. The open home network framework of claim 8, wherein the communication API includes:
a STB tuner API for controlling a broadcasting tuner related to a broadcasting service;
an I/O communication API for controlling I/O driver provided in the platform;
a low band communication API for controlling hardware which provides data with a low transmission rate;
a high band communication API for controlling hardware which provides data with a high transmission rate; and
a common communication API for recognizing newly added hardware drivers or devices and transmitting the newly added hardware drivers or devices to the framework management function through a common interface.

17. The open home network framework of claim 12, wherein the execution management component includes an event management, a user management, a service management, a resource management, a user interface management and an execution management.
